(19) United States
(12) Patent Application Publication
(10) Pub. No.: US 2003/0091754 A1
(43) Pub. Date: May 15, 2003

(54) Method for treating cellulosic fibres

(76) Inventors: Thami Chihani, (US); Panayotis Cocolios, Bullion (FR); Franck Forster, Hamburg (DE); Bernd Martens, Hamburg (DE); Anna Nihlstrand, M?ouml;lndal (SE); Eckhard Prinz, Hamburg (DE)

Correspondence Address: Air Liquide, Intellectual Property Department, Suite 1800, 2700 Post Oak Boulevard, Houston, TX, 70056, US

(21) Appl. No.: 10/203,500

(22) PCT Filed: Jan. 19, 2001
(86) PCT No.: PCT/EP01/00622

(30) Foreign Application Priority Data
Feb. 11, 2000 (EP) 00400401.4

(51) Int. Cl. H05H 1/48

(52) U.S. Cl. 427/580

(57) ABSTRACT

A method for treating cellulosic fibres, according to which the fibre is submitted to an electrical discharge, in presence of a treatment gaseous mixture comprising a carrier gas, as well as a reducing gas and/or an oxidizing gas, at the atmospheric pressure, characterized in that:

when the treatment gaseous mixture comprises an oxidizing gas, the content of the oxidizing gas in the mixture is in the range 50 to 2000 ppm vol,

when the treatment gaseous mixture comprises a reducing gas, the content of the reducing gas in the mixture is in the range 50 to 30000 ppm vol.

The present invention relates to a method for modifying the surface of cellulose-containing fibres, to the surface-modified fibres and to the products that can be made from such fibres. These include fibrous structures (or fibrous webs), including paper or non-woven articles, especially hygienic products, such as tissue paper and non-woven wipers. The fibrous structure can further be used for making different kinds of paper, e.g. fine paper.

The present invention also relates to a method of making such fibrous structures and the final structures obtainable from such fibrous structures.

The wording “cellulose containing fibres” should be understood according to the present invention as all kind of fibres containing cellulose, either natural fibres or synthetic fibres, e.g. pulp but also regenerated cellulose fibres like rayon or viscose.

The wording “fibrous structure” should be understood according to the present invention as covering intermediate products, having one or more layers.

The terms “paper” and “non-woven” should be understood according to the present invention as covering final products.

Depending on the kind of cellulose-containing fibrous structures and applications considered, properties of wet strength, wettability, adhesion, storage stability, or else absorption kinetics and capacity will be particularly looked for.

Fibrous structures comprising cellulose-containing fibres have a wide range of use in products such as printing paper, Kraft paper, packaging paper, tissue paper, wipes for households use, as well as heavy duty in the industry. The common feature for all these fibrous structures is that they have to show at least some strength when being wet.

“Non-woven” is commonly understood as an independent group of products. These composite materials are made up from endless filaments, shorter staple fibres or micro-fibres that have been bonded together to a mat, by e.g. intertwining, by cohesive or adhesive bonding. The fibres may be synthetic, natural fibres or blend of synthetic and natural fibres. Examples of natural fibres are cotton and cellulose pulp fibres (one can for example report to standards DIN 61 210 T2 of October 1998 and IS 9092-EN29092).

Paper, cardboard and paperboard are essentially composed of fibres of vegetable origin and formed by drainage of a fibrous suspension on e.g. a screen and subsequently drying of the formed web (one can for example report to the standard DIN 6730, May 1996).

The range of the basis weight differs between the various products of this group: for paper less than 225 g/m², for cardboard the range being 150 g/m² to 600 g/m² and for paperboard above 225 g/m².

Tissue paper is a sub group of paper having low basis weights normally less than 40 g/m². Tissue paper is porous, absorbent paper and normally elastic due to foreshortening of either the wet or the dry sheet, e.g. creping. In the final products, tissue plies produced on a tissue paper machine are often bonded to other tissue plies.

Although structures comprising cellulose-containing fibres often have good strength properties in dry conditions, they lose it when the fibres get wet. The reason is that the fibres are held together with hydrogen bonds formed between fibres and/or with inter-fibre frictional forces. In water and other polar solvents, the hydrogen bonds between the pulp fibres more or less disappear and the strength of the material becomes very dependent on the friction between the fibres.

This sensitivity to polar solvents can be reduced by the addition of various binders. For non-woven of conventional type, the following components can for example be used latex based on ethylvinyl acetate, acrylates, polyvinyl alcohol or styrene-butadiene. Wet strength resins, for example polyamide-epichlorhydrin (PAE) resins, urea formaldehyde (UF), polyethylene imine and different starches can be used to increase the wet strength for non-woven as well as paper.

Most of the wet strength resins contain some kind of reactive groups, such as unsaturated groups (double or triple bounds), epoxy-, amine-, hydroxy- or carboxylic groups. These reactive groups will react or interact with chemical groups within other wet strength resin molecules or chemical groups situated on cellulose containing fibres.

Reinforcement of structures comprising cellulose-containing fibres with the help of various binders and wet strength resins can result in a number of problems of more or less serious nature depending on where and how the material is to be used. Certain chemical binders have poor resistance to commonly occurring solvents, something which is a significant drawback for structures that are used in wiping clothes. The use of binders and wet strength resin often leads to a stiffening of the structures, which is also a significant drawback for hygienic and wiping applications in which a soft and drapable structures are asked for and/or required. Furthermore, the addition of a binder is a chemical treatment which is often less desirable from an environmental point of view.

In addition, it should be mentioned that the incorporation of resins leads to a decrease of water absorption kinetics and capacity, due to the hydrophobic nature of many resins.

Another method of raising the wet strength in structures comprising cellulose-containing fibres is by thermo-bonding, which can be used where the structures also contain thermoplastic fibres or particles. In such cases the thermoplastic fibres in the materials are melted by means of raised temperature and if needed pressure. The drawback with this method is that the structures become stiffer and fused thermoplastic fibres can locally form hard regions which can score delicate surfaces or the skin of the user. A further drawback with the thermal bonding is that the fibre recycling becomes more difficult.

In addition, the same remark (above mentioned) concerning a decrease of water absorption kinetics and capacity, due to the hydrophobic nature of such resins, can be made here.

A number of methods for chemically-physically affecting the surface of different materials have been developed. Among these methods there can be mentioned methods using ultraviolet light, plasma, or else corona discharge. One of the advantages of these methods is that the material is gently treated and no subsequent drying or post-treatment is required.

“Plasma” should be understood as the general term for gases in a state which comprises ions, electrons, free radicals, and photons within the UV-range, but also molecules and atoms. Plasma is electrically neutral and is normally generated by an energy source, for example by an electrical discharge, or else by microwaves.

Plasma treatment can be said to be a further development of corona treatment and the primary difference is that corona treatment takes place at atmospheric pressure whilst so-called glow discharge in cold plasma takes place at reduced pressure. Plasma treatment can be executed in the presence of different gases depending on which result is desired.

Plasma treatment is used nowadays, for example, to provide plastic components with a coatable surface. It is also used to chemically modify the surface on fibres with an aim to increase the wettability of fibres as well as to increase the adherence between fibres and filler.

Corona treatment has for long been used to morphologically and chemically modify the surface of polymer films and in particular for the purpose of improving the adhesion of printing inks or to perforate the film. Apparatus for corona treatment is described in, for example, U.S. Pat. No. 4,283,291. It is also known from, for example, U.S. Pat. No. 4,535,020 and EP-A-0,483,859 to treat surface materials for absorbent products such as diapers and sanitary napkins with corona at the same time as the material is also treated with a surfactant to increase the liquid permeability. Thanks to the corona treatment, an improved permanent wettability is attained. In EP-A-0,484,830 it is disclosed that wiping clothes of, for example, meltblown material can be treated with corona to provide the material with improved permanent absorption properties.

Furthermore, WO 96/27044 proposes that a hydro-entangled non-woven material is subjected to a plasma or corona treatment to achieve a higher wet strength. The non-woven material comprises cellulose containing fibres.

An increase in the fibre-to-fibre friction, also when the material is wet, is proposed in WO 96/27044 as a reason for the wet strength increase. It is also known from SE-A-9804294 that a tissue material that comprises fibres and wet strength resin can be treated with corona to enhance the initial wet strength of paper. This procedure makes it possible to cut the curing time of the wet strength resin to a minimum.

On the other hand, the document U.S. Pat. No. 5,576,076 describes a method to treat a substrate, for example a cellulose-containing substrate such as paper or paper board, with electrical discharge in an atmosphere containing silane, an oxidizing agent such as oxygen, and an inert carrier gas. The European patent application N^{o}9840201.7 describes tissue treated with the aforementioned method. The aim of the treatment in both documents is to get a better wettability of the product.

One of the objects of the present invention is to propose a method for modifying the surface of cellulose-containing fibres in order—depending on the specifications required by each final product—to enhance strength properties, wettability, storage stability, absorption kinetics and capacity.

A further object of the invention is a method of modifying the surface of cellulose-containing fibres in such a manner that they exhibit a higher density of functional groups on the surface, such as carboxylated groups or else that they exhibit new nitrogen-containing groups.

Another object of the invention is to provide surface modified cellulose-containing fibres with improved strength properties wettability and storage stability. The fibres having been modified with the method according to the invention.

A further object is to provide surface modified cellulose-containing fibres showing increased number of carboxylated and nitrogen-containing groups attached to the surface of the cellulose containing fibres with chemical bonds, e.g. covalent bonds. The fibres can be treated either separately, before they have been formed to a structure, or within a structure e.g. after they have been formed to a web.

Another object of the invention is a fibrous structure comprising the surface modified cellulose containing fibres with carboxylated and nitrogen-containing groups attached to the fibre surface.

A further object of the invention are products, such as tissue paper and non-woven wipes, comprising surface modified cellulose containing fibres with carboxylated and nitrogen-containing groups attached to the fibre surface.

The method according to the present invention, for treating cellulosic fibres, according to which the fibre is submitted to an electrical discharge, in presence of a treatment gaseous mixture comprising a carrier gas, as well as a reducing gas and/or an oxidizing gas, at the atmospheric pressure, is characterized the following way

when the treatment gaseous mixture comprises an oxidizing gas, the content of the oxidizing gas in the mixture is in the range 50 to 2000 ppm vol,

when the treatment gaseous mixture comprises a reducing gas, the content of the reducing gas in the mixture is in the range 50 to 30000 ppm vol.

The method according to the present invention may also adopt one or more of the following characteristics

when the treatment gaseous mixture comprises an oxidizing gas, this oxidizing gas is CO₂ or N₂O or H₂O or a mixture thereof.

more carboxylated functional groups are introduced at the surface of the fibres during the treatment (in comparison with the surface state of the fibres before treatment).

at least nitrogen-containing functional groups are introduced at the surface of the fibres during the treatment.

the treatment gaseous mixture comprises a carrier gas, a reducing gas and an oxidizing gas, and R being the ratio between said content of reducing gas and said content of oxidizing gas, 0<R<15.

said content of oxidizing gas is in the range 100 to 1000 ppm vol., the ratio R being in the range 0.5≦R≦8.

said contents and said ratio R are controlled in order to obtain a surface tension of a fibrous structure including the fibres this way treated of 40 to 50 mN/m.

said contents and said ratio R are controlled in order to obtain a surface tension of a fibrous structure including the fibres this way treated higher than 50 mN/m.

said contents and ratio R are controlled in order to obtain a water contact angle on the fibres this way treated between 0 and 50°.

said contents and ratio R are controlled in order to obtain a water contact angle on the fibres this way treated between 0 and 30°.

said reducing gas is hydrogen.

said carrier gas is nitrogen, argon or helium or a mixture thereof.

the fibre has been, prior to said treatment, submitted to a pre-treatment, by being submitted to an electrical discharge, in presence of a pre-treatment gaseous mixture comprising air or an inert gas or a mixture thereof.

the inert gas of the pretreatment is advantageously nitrogen, argon or helium or a mixture thereof.

The notion of “oxidizing gas” according to the invention covers therefore oxygen or any other oxygen-containing gases such as, for instance, CO, CO₂, NO, H₂O, N₂O or NO₂: As mentioned previously, it is preferred to use according to the invention CO₂ or N₂O or H₂O or a mixture thereof.

The fibres can be treated individually, for example mixed in a fluidising medium, e.g. in a gas. Fibres that are treated individually can be modified to give a fibrous structure a higher dry and wet strength. A non-exclusive theory to the achieved increase of the strength properties is that chemical active groups, e.g. carboxylate or nitrogen-containing groups formed on the surface of fibres during the modification will interact with other formed active groups on other fibres or directly with the untreated surface of other fibres. If the fibres are treated with wet or dry strength agents to further increase the strength properties of a formed fibrous structure the active groups on the fibres may interact with these strength agents and so achieve a crosslinking between the fibres. These interactions achieve more or stronger bonds between the fibres and the strength agent than is common when the fibres are untreated. The interaction described above may be for example hydrogen bonds, covalent bonds or ionic bonds. The interaction between different groups is most probably established when the modified cellulose containing fibres are formed to a fibrous structure e.g. by one of the methods described hereinafter.

The fibres may also be modified after they have been formed to a fibrous structure. If the fibres are treated after the formation of a fibrous structure the modification will mostly give rise to changes in wettability and storage stability. According to the invention the fibrous structure can be treated when it is still wet, e.g. on a machine forming the fibrous structure or when it is dry e.g. during converting of the fibrous structure to the final product.

During production of nonwoven fibrous structure fibres are air- or wet- or foam-formed on a wire. Thereby are the fibres dispersed in a gas, in a liquid or in a foamed liquid respectively, subsequently placed on a wire whereby any dispersing liquid or gas is drained by processes known per se, see e.g. SE 9402470 A, CA 841,938. Thereafter the fibres are hydro-entangled bonded to form a fibrous structure. Other ways of bonding the fibres is using bonding agents, thermobonding by melting some of the fibres and part of fibres in the fibre mixture or by needling.

The fibres can be bonded by hydro-entanglement with an energy input in the range 200-800 kWh/ton. The hydro-entanglement takes place using conventional methods and equipment. The hydro-entanglement of wet- or a foam-formed fibre web can either take place in-line i.e. immediately after the fibre has been drained on the wire or on a web, which has been dried. A plurality of wet and/or dry fibrous structures can also be laminated together by hydro-entanglement forming a layered fibrous structure or by other bonding methods.

The invention is of particularly great significance for wet and foam-formed nonwoven material where the choice of fibres is more restricted since too long fibres are difficult to disperse in liquid or foam. The problem with sufficient wet strength is normally greater in material containing short fibres.

During the production of paper webs the fibres are dispersed in water and introduced onto a draining wire through a headbox, the formed web is drained and dried. Tissue paper is usually creped on a Yankee cylinder during the drying. Other paper qualities can be sized and or calandered if it necessary for the quality. The headbox may have more than one nozzle for forming a layered fibrous structure.

As already mentioned, the term “cellulose containing fibres” is used for all fibres that contain cellulose, being either of natural or synthetic nature.

The natural fibres are made from plant fibres from e.g. hardwood, softwood or cotton. Fibres from esparto grass, bagasse, (cereal straw, rice straw, bamboo, hemp), kemp fibres flax or other woody and cellulosic fibres can also be used as raw material. These fibres can be treated according to different chemical and mechanical methods before they are treated with the method according to the invention. The fibres may further be primary (virgin) fibres or secondary fibres (from waste paper).

The chemical methods for making a chemical pulp can be the sulphite process the sulphate or Kraft process, the soda process or process using organic solvents (e.g. Organosolv, organocell, Alcell). Modified method of these processes can also be used.

The mechanical pulp can be groundwood pulp or refiner pulp. The refiner pulp can be further subdivided into thermo-mechanical pulp (TMP), and chemo-thermo-mechanical pulp (CTMP and other subgroups thereof).

The fibres can further be bleached with known methods.

As the man skilled in the art knows, the different ways of making the fibres have an influence on the surface chemistry of the final fibres. A fibre produced by a mechanical method will contain much more lignin and hemicellulose than a bleached fibre made by some of the chemical methods. These differences will give different surface properties to the fibres and different reaction behaviour when treated according to the invention.

Different types of synthetic cellulose containing fibres may be fibres made from regenerated cellulose such as rayon or viscose fibres.

The cellulose containing fibres can also be mixed with other synthetic fibres, e.g. polyester, polyamide or the like. Any mixture that still contains at least 10%, 30% or 50%, by weight of cellulose containing fibres is according the invention still a web comprising cellulose containing fibres.

The cellulose containing fibres may preferably be fibrillated before the treatment according to the invention. During the fibrillation the surface layer of the fibres is torn open and partially removed. This increases the surface area and the bonding capacity of the fibres. During the fibrillation some of the fibres are also ruptured in to smaller pieces. The fibrillation changes the static and dynamic strength properties of the fibres. The fibres can be fibrillated in a refiner known in the state of the art.

The fibrous structure of the invention comprises surface modified fibres according to the invention. The fibrous structure may also comprise cellulose-containing fibres with a surface that has not been modified according to the invention. The content such non-modified cellulose-containing fibres may be according to the invention up to 90%, 70% or 50%, by weight based on the weight of the structure.

A layer as described in this application is a fibrous structure. A multi-layer structure contains more than one layer that are bonded together by covalent and/or hydrogen bonds and/or by other conceivable bonds. The fibrous structure may consist of one or more layers, preferably 1-10, which cannot be separated from each other. The modified fibres according to the invention may be present in all layers in a layered structure or in just some of the layers.

The fibrous structure of the invention can also comprise synthetic fibres, e.g. polyester, polyamide or the like that are surface modified but also such synthetic fibres that are not modified. The amount of synthetic fibres can be up to 10%, 50% or 80% by weight based on the weight of the structure. The synthetic fibres may be present in all layers in a layered structure or in just some of the layers.

The fibrous structure according to the invention may have a basis weight in the range 8-300 g/m².

Even if it is possible to make a fibrous structure that has a good wet strength without wet strength agents according to the invention, the addition of wet strength agents may be appropriate in individual cases in order to achieve a further improvement in strength properties. Examples of suitable wet strength agents are: carboxymethylcellulose, polyamide-epichlorhydrin (PAE), polyacryl amide urea formaldehyde resins and pre-polymers, melamine formaldehyde resins and pre-polymers as well as phenol formaldehyde resins and pre-polymers.

Paper and nonwoven products according to the invention comprise the fibrous structure of the invention. The products can be made up by one or more plies. At least one ply is made of the fibrous structure according to the invention described above.

A ply in the sense of the invention is a fibrous structure as described above. Plies can be bonded together with adhesives or embossing in such a way that it will be possible to at least partially separate them from each other. A ply comprises one or more layers with the same or different compositions. One or more of the plies of a multiply paper may consist of conventional non-modified fibres, e.g. cellulose-containing fibres or synthetic.

Examples of tissue paper products and nonwoven products are:

Wiping clothes for domestic or industrial use;

Sanitary products like toilet paper, handkerchiefs, facials and napkins/serviettes;

Disposable garments or bed-linen.

The fibrous structures that may be one ply of a product according to the invention are converted to a sellable product. During the converting the fibrous product may be embossed and/or printed and/or provided with an active ingredient such as an softening or caring lotion or an detergent. The paper/nonwoven product may exist as a sheet or as a roll.

The paper/nonwoven according to the invention preferably has a basis weight of 20 to 300 g/m², in the case of tissue product the basis weight is usually 10 to 60 g/m² and for nonwoven 30 to 200 g/m².

1. A method for treating cellulosic fibres, according to which the fibre is submitted to an electrical discharge, in presence of a treatment gaseous mixture comprising a carrier gas, as well as a reducing gas and/or an oxidizing gas, at the atmospheric pressure, characterized the following way:
when the treatment gaseous mixture comprises an oxidizing gas, the content of the oxidizing gas in the mixture is in the range 50 to 2000 ppm vol,
when the treatment gaseous mixture comprises a reducing gas, the content of the reducing gas in the mixture is in the range 50 to 30000 ppm vol.

2. The method of claim 1 characterized in that when the treatment gaseous mixture comprises an oxidizing gas, this oxidizing gas is CO₂ or N₂O or H₂O or a mixture thereof.

3. The method of claim 1 or 2 characterized in that more carboxylated functional groups are introduced at the surface of the fibres during the treatment.

4. The method according to one of claims 1 to 3 characterized in that at least nitrogen-containing functional groups are introduced at the surface of the fibres during the treatment.

5. The method according to one of claims 1 to 4 characterized in that the treatment gaseous mixture comprises a carrier gas, a reducing gas and an oxidizing gas, and in that R being the ratio between said content of reducing gas and said content of oxidizing gas, 0<R<15.

6. The method according to claim 5, characterized in that said content of oxidizing gas is in the range 100 to 1000 ppm vol., the ratio R being in the range 0.5≦R≦8.

7. The method according to claim 5 or 6, characterized in that said contents and ratio R are controlled in order to obtain a surface tension of a fibrous structure including the fibres this way treated of 40 to 50 mN/m.

8. The method according to claim 5 or 6, characterized in that said contents and ratio R are controlled in order to obtain a surface tension of a fibrous structure including the fibres this way treated higher than 50 mN/m.

9. The method according to claim 5 or 6, characterized in that said contents and ratio R are controlled in order to obtain a water contact angle on the fibres this way treated between 0 and 50°.

10. The method according to claim 5 or 6, characterized in that said contents and ratio R are controlled in order to obtain a water contact angle on the fibres this way treated between 0 and 30°.

11. The method according to one of claims 1 to 10 characterized in that said reducing gas is hydrogen.

12. The method according to one of claims 1 to 11, characterized in that said carrier gas is nitrogen, argon or helium or a mixture thereof.

13. The method according to one of claims 1 to 12, characterized in that the fibre has been, prior to said treatment, submitted to a pre-treatment, by being submitted to an electrical discharge, in presence of a pre-treatment gaseous mixture comprising air or an inert gas or a mixture thereof.

14. The method of claim 13, characterized in that said inert gas of the pretreatment is nitrogen, argon or helium or a mixture thereof.

15. Method according to one of claims 1 to 14, wherein the fibres are treated when they are dispersed in a gaseous medium.

16. The method according to one of claims 1 to 14, characterized in that the fibres are treated after they have been formed to a fibrous structure (web).

17. Method according to claim 16 characterized in that the web is drylaid.

18. Method according to claim 16 characterized in that the web is wetlaid.

19. Method according to one of claims 16 to 18 wherein the fibres in the web are bonded to each other before or after the treatment.

20. Method according to claim 19 wherein the fibres are treated on a paper machine or on a non-woven machine.

21. Method according to claim 16 wherein the fibrous structure is treated when wet.

22. Method according to claim 21 wherein the fibres are treated after the drying step inside a paper or a non-woven machine or at the converting step.

23. A fibrous structure comprising fibres treated according to the method according to anyone of claims 1 to 22.

24. A fibrous structure according to claim 23, characterized in that the structure comprises more than one layer and in that at least one of said layers comprises fibres treated according to the method according to anyone of claims 1 to 22.

25. A nonwoven or tissue paper product characterized in that the product comprises fibres treated according to the method according to anyone of claims 1 to 22.

26. A nonwoven or tissue paper product according to claim 25, characterized in that the product comprises also non-treated cellulose-containing fibres, the content of said non-treated fibres in the product being up to 90%, preferably up to 70%, or more preferably up to 50%, by weight of the product.

27. A nonwoven or tissue paper product according to claim 25 or 26, characterized in that the product comprises more than one ply, whereby at least one of said plies comprises fibres treated according to the method according to anyone of claims 1 to 22.

28. A nonwoven or tissue paper product according to one of claims 25 to 27, characterized in that the product also comprises synthetic fibres.

29. A nonwoven or tissue paper product according to claim 28, characterized in that at least some of said synthetic fibres have been treated according to the method according to anyone of claims 1 to 22.

30. Use of fibres treated according to the method according to anyone of claims 1 to 22 for making tissue products.
